(19) United States
(12) Patent Application Publication
(10) Pub. No.: US 2012/0133282 A1
(43) Pub. Date: May 31, 2012

(54) EXTERNAL STATE OF CHARGE INDICATOR SYSTEM FOR AN AUTOMOTIVE VEHICLE

(75) Inventors: Fernando Rubio, San Diego, CA (US); Paul Thomas Geantil, San Diego, CA (US)

(73) Assignee: APTERA MOTORS, INC., Oceanside, CA (US)

(21) Appl. No.: 12/956,613

(22) Filed: Nov. 30, 2010

(51) Int. Cl. B60Q 1/14

(52) U.S. Cl. 315/77

(57) ABSTRACT

An automotive vehicle system includes a light and a module. The light is adapted to be attached to an exterior of a vehicle. The module selectively illuminates the light during a vehicle stationary period based on an electric drive system state of charge. The module further selectively illuminates the light during a vehicle driven period based on vehicle operating conditions different than the electric drive system state of charge.

### BACKGROUND AND SUMMARY

The present disclosure generally pertains to automotive vehicles having an electric drive system, and more particularly, to systems that indicate a state of charge of the electric drive system.

Automotive vehicles may be propelled by an electric drive system used alone, or in combination with a hybrid internal combustion engine, to produce drive torque for driving wheels of the vehicle. Electric drive systems typically include an electric motor that converts electrical energy into drive torque. A rechargeable battery or batteries arranged in a battery pack supply the energy and, generally, a range of the vehicle depends on an amount of energy available from the batteries. As the vehicle is driven, energy is drawn from the batteries and after periods of sustained vehicle operation, the batteries must be recharged to ensure the vehicle has a desired range. Plug-in hybrid and pure electric vehicles use an external electric power source to recharge the batteries. To recharge the batteries, the power source is plugged into a receptacle located in a charge port accessible from an exterior of the vehicle.

The range and/or a remaining amount of energy in the batteries may be communicated to a driver or other user of the vehicle. Similar to a fuel gauge of a gasoline vehicle, a gauge or other display located on an instrument panel is typically used to indicate an energy level of the batteries, or what is more commonly referred to as a state of charge (SOC). SOC indicators located on the instrument panel may not be visible or legible from an exterior of the vehicle. Additionally, SOC indicators may be turned off during periods when the vehicle is not driven.

In accordance with the present invention, an automotive vehicle system and a method for an automotive vehicle are provided. In one aspect, the automotive vehicle system includes a light adapted to be attached to an exterior of a vehicle, and a module selectively illuminating the light. The module selectively illuminates the light during a vehicle stationary period based on an electric drive system SOC. The module selectively illuminates the light during at least a vehicle driven period based on at least one vehicle operating condition different than the electric drive system SOC. In another aspect, the method includes selectively illuminating a light disposed on an exterior of the vehicle during a first period when the vehicle is stationary based on an SOC of an electric drive system. The method further includes selectively illuminating the light during at least a second period when the vehicle is driven based on at least one vehicle operating condition different than the SOC.

The automotive vehicle system and the method each include a light that is illuminated based on the SOC and that serves as an external SOC indicator. The external SOC indicator is advantageous over traditional SOC indicators provided in an interior of the vehicle. For example, the external SOC indicator provides a more convenient way for communicating the SOC during recharging by obviating the need to enter the vehicle and turn vehicle accessories on to ascertain the SOC. The external SOC indicator also provides a convenient way for externally communicating the SOC when the vehicle is operated in a park mode. Additionally, the external SOC indicator can be used to communicate the SOC to a vehicle operator located at least around six to ten feet away from the vehicle. Additional advantages and features of the present invention will be found in the following description and accompanying claims, as well as in the appended drawings.

### BRIEF DESCRIPTION OF THE DRAWINGS

The present disclosure will become more fully understood from the detailed description and the accompanying drawings, wherein:

FIG. 1 is a perspective view showing a vehicle according to the present disclosure;

FIG. 2 is a rear elevation view of the vehicle showing an external SOC indicator according to the present disclosure;

FIG. 3 is a fragmentary, perspective view showing another external SOC indicator according to the present disclosure;

FIG. 4 is a functional block diagram showing a fragmentary, cross-sectional view of the external SOC indicator shown in FIG. 3 taken along line 4-4;

FIG. 5 is a functional block diagram showing a vehicle control system according to the present disclosure overlaid on top of the vehicle;

FIG. 6 is a functional block diagram showing an SOC indicator system according to the present disclosure;

FIG. 7 is a block diagram showing an end elevation of another external SOC indicator according to the present disclosure;

FIG. 8 is a fragmentary, perspective view of another external SOC indicator according to the present disclosure; and

FIG. 9 is an end elevation view of the external SOC indicator shown in FIG. 8.

### DETAILED DESCRIPTION

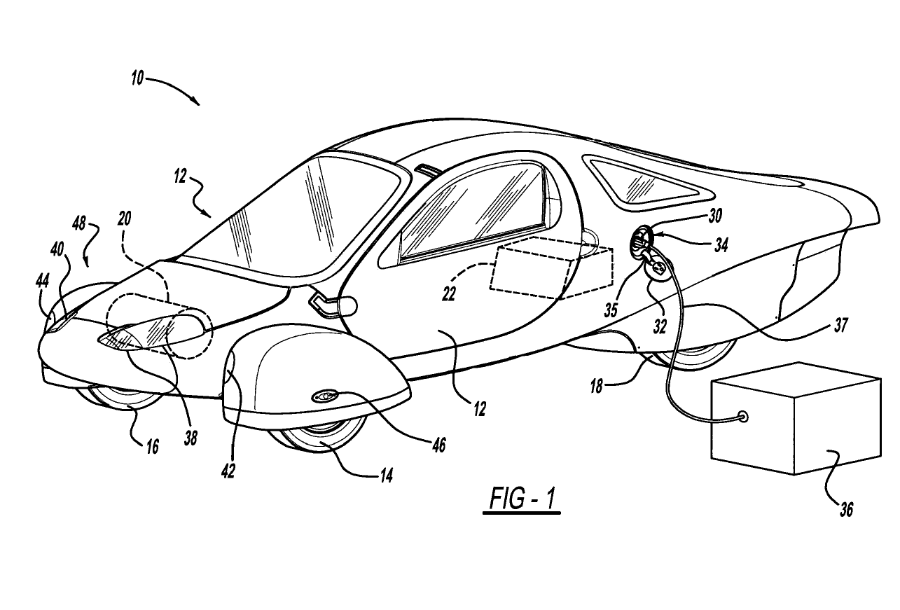

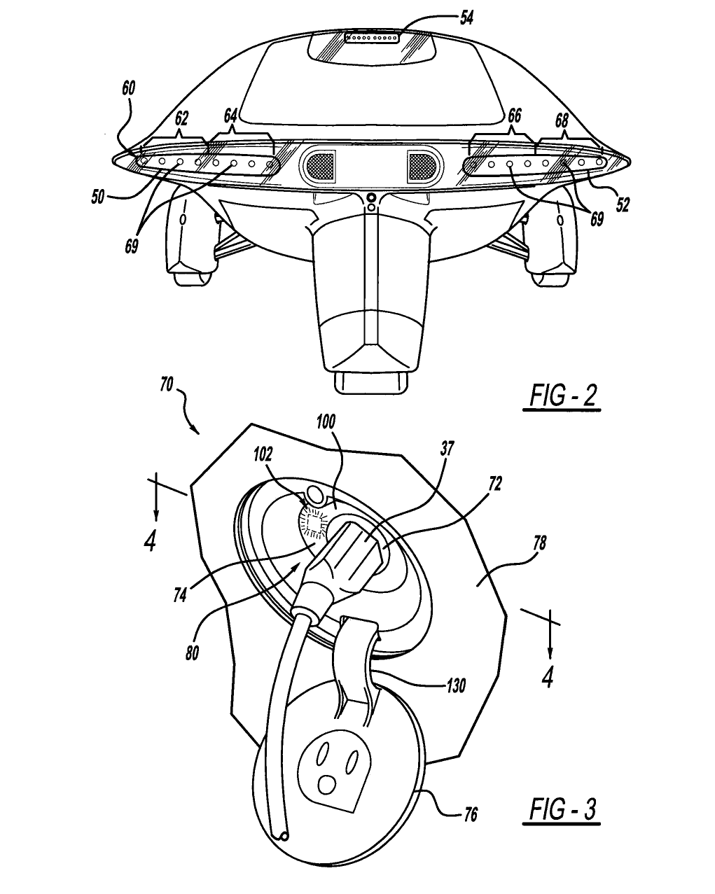

Referring to FIGS. 1-2, an exemplary vehicle 10 including an external SOC indicator according to the present disclosure is shown. Generally, vehicle 10 is a pure electric vehicle having two doors 12 and three wheels 14, 16, 18. Vehicle 10 has a front-wheel-drive layout and is propelled by an electric drive system coupled to front wheels 14, 16. The electric drive system produces drive torque used to drive one or both the front wheels 14, 16. The electric drive system includes an electric motor 20 and a battery pack 22. Electric motor 20 converts electrical energy supplied by the battery pack 22 into drive torque. Battery pack 22 includes rechargeable batteries that supply energy to electric motor 20. In a preferred implementation, battery pack 22 includes two or more lithium ion batteries connected in series. More specifically, battery pack 22 includes two or more lithium iron phosphate (LiFePO4) batteries, also referred to as LFP batteries.

It will be appreciated from the following description, that the present invention is not limited to pure electric vehicles or vehicles having a particular drive layout. For example, the present disclosure applies equally to hybrid vehicles having an internal combustion engine used in combination with an electric drive system and vehicles having an all-wheel-drive or rear-wheel-drive layout. Additionally, the present invention is not limited to rechargeable batteries or battery packs of a particular chemistry or arrangement. For example, the present invention applies equally to lithium ion, nickel-metal hydride, and other battery chemistries. The present invention also applies equally to battery packs having batteries arranged in series and/or in parallel.

Vehicle 10 includes a charging receptacle 30 and, optionally, an access door 32. Charging receptacle 30 is disposed on an exterior of vehicle 10 within a charging port 34 and is electrically coupled to battery pack 22. In various configurations, charging receptacle 30 includes conductive female terminals that create at least part of a conductive path connecting charging receptacle 30 and battery pack 22. Access door 32 is disposed adjacent to an opening of charging port 34 and provides selective access to charging receptacle 30. Access door 32 is mechanically coupled to vehicle 10 via a hinge mechanism 35. In a closed position, access door 32 covers the opening of charging port 34. In an open position, access door 32 provides access to charging receptacle 30 via charging port 34.

Vehicle 10 is recharged by connecting an external power source 36 to charging receptacle 30. External power source 36 is coupled to charging receptacle 30 by a charging plug 37. During periods when vehicle 10 is recharging, charging receptacle 30 communicates charging energy supplied by external power source 36 to battery pack 22. During periods when vehicle 10 is recharging or is stationary (e.g., in a park mode), a driver or other user may desire to know a current SOC of vehicle 10. For example, a user may desire to know the current SOC in order to determine whether vehicle 10 has a range sufficient for a next trip.

In various implementations, the external SOC indicator is created by selectively illuminating one or more exterior signals and/or lights of vehicle 10 based on a current SOC. The signals and/or lights creating the external SOC indicator may have a dual-purpose of performing an exterior signaling or lighting function separate from an SOC indicating or communication function. For example, various signals and/or lights may provide illumination for the driver to operate vehicle 10 safely after dark and/or to increase the visibility of the vehicle 10. The signals and/or lights may provide illumination for displaying information about the vehicle's presence, position, direction of travel, and driver's intentions regarding direction and speed of travel.

Accordingly, the external SOC indicator can be created by selectively illuminating one or more headlights 38, 40, front position/directional indicators 42, 44, sidemarker lights 46, 48, rear position or tail lights 50, 52, a center high mount stop light (CHMSL) 54, and reversing lights 56, 58. When performing the SOC communication function, one or more of headlights 38, 40, front position/directional indicators 42, 44, sidemarker lights 46, 48, rear position or tail lights 50, 52, a center high mount stop light (CHMSL) 54, and reversing lights 56, 58 can be illuminated based on the current SOC. When performing an exterior lighting function, headlights 38, 40, front position/directional indicators 42, 44, sidemarker lights 46, 48, rear position or tail lights 50, 52, a center high mount stop light (CHMSL) 54, and reversing lights 56, 58 are illuminated for at least a period based on one or more operating conditions different than the current SOC. The operating conditions can include, but are not limited to, a headlight switch position and/or an amount of ambient light, turn signal indicator switch position, and a brake pedal position.

According to a first embodiment, an external SOC indicator 60 is created by tail lights 50, 52. In addition to performing exterior lighting functions of increasing visibility of vehicle 10 from the rear and indicating a driver's intention to change direction or slow vehicle 10, tail lights 50, 52 are used to communicate the current SOC. During periods when vehicle 10 is driven (i.e., vehicle driven periods), tail lights 50, 52 may be illuminated at a first intensity when front position lights (e.g., front position/directional indicators 42, 44) are illuminated, including when headlights 38, 40 are illuminated. Tail lights 50, 52 may be illuminated at a second intensity greater than the first intensity to indicate the driver's intention to stop or slow vehicle 10. Tail light 50 may flash intermittently at the second intensity to indicate the driver's intention to turn left. Tail light 52 may flash intermittently at the second intensity to indicate the driver's intention to turn right. During periods when vehicle 10 is operated in a park mode and/or is recharging (i.e., vehicle stationary periods), tail lights 50, 52 are selectively illuminated to display information about the current SOC of vehicle 10. Tail lights 50, 52 may illuminate at the first intensity, the second intensity, or a combination thereof when displaying the information about the current SOC.

According to the first embodiment, SOC indicator 60 is created by selectively illuminating independent lighting sections 62, 64 of tail light 50 and lighting sections 66, 68 of tail light 52 based on the current SOC. Each of the lighting sections 62, 64, 66, 68 includes one or more light sources 69 that can be independently illuminated. For example, each of the lighting sections 62, 64, 66, 68 may be powered by a separate power circuit connected to a common power supply, such as battery pack 22. It is contemplated that light sources 69 can be at least one of several types, including but not limited to, incandescent, fluorescent, halogen, light emitting diode, and fiber optic type light sources. As used herein, the phrase at least one of A, B, and C should be construed to mean a logical (A or B or C), using a non-exclusive logical or.

In an exemplary configuration, lighting sections 62, 64, 66, 68 are linearly arranged across a rear portion of vehicle 10. Lighting sections 62, 64, 66, 68 are illuminated in predetermined combinations to convey the current SOC. In an exemplary implementation, lighting section 62 is illuminated and lighting sections 64, 66, 68 remain off when the current SOC is within a predetermined first SOC range from zero percent (0%) to twenty five percent (25%). Lighting sections 62, 64 are illuminated and lighting sections 66, 68 remain off when the current SOC is within a predetermined second SOC range from twenty-six percent (26%) to fifty percent (50%). Lighting sections 62, 64, 66 are illuminated and section 68 remains off when the current SOC is within a predetermined third SOC range from fifty-one percent (51%) to seventy-five percent (75%). Sections 62, 64, 66, 68 are illuminated when the current SOC is within a predetermined fourth SOC range from seventy-six percent (76%) to one hundred percent (100%) or fully charged.

From the foregoing, it will be appreciated that tail lights 50, 52 create a bar graph indicator that can convey information about the current SOC to an observer located at least around six to ten feet away from vehicle 10. In particular, tail lights 50, 52 convey whether the current SOC is within one of four mutually exclusive SOC ranges. The bar graph indicator is created using automotive exterior lighting components used for other purposes, obviating the need for a separate and/or dedicated lighting apparatus to convey information about the current SOC outside of vehicle 10. Additionally, since tail lights 50, 52 are designed to be visible at relatively large distances from vehicle 10 when illuminated, the current SOC can be conveyed to an observer located at large distances.

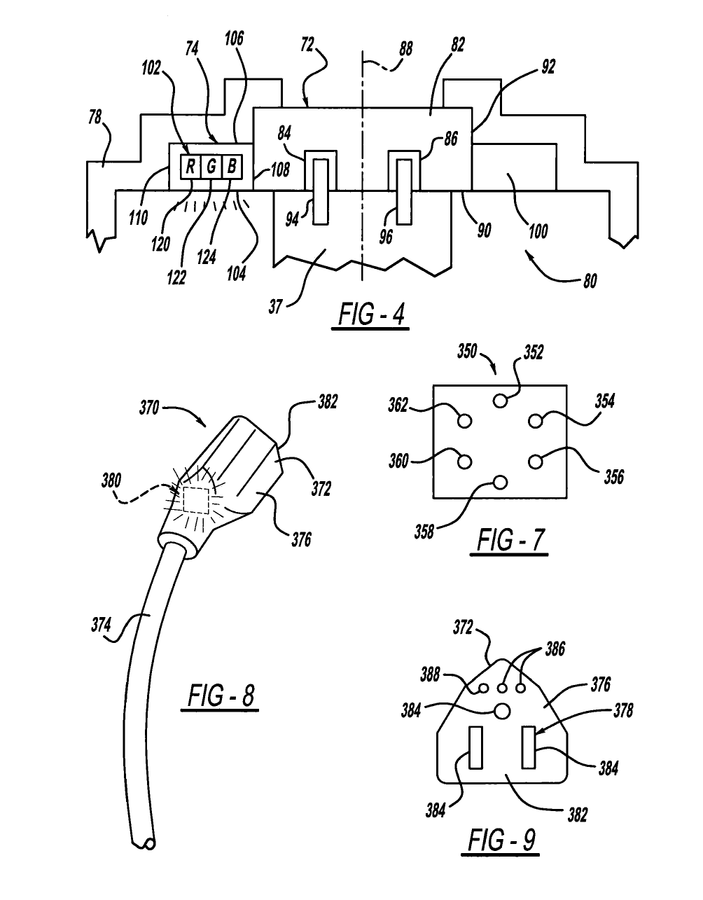

In various other implementations, an SOC indicator according to the present invention is created by selectively varying a color displayed by a lighting component or apparatus disposed on an exterior of vehicle 10 based on a current SOC. Referring now to FIGS. 3-4, an apparatus 70 including an external SOC indicator according to a second embodiment is shown. Apparatus 70 includes a charging receptacle 72, an external SOC indicator 74, and, optionally, an access door 76. Charging receptacle 72 is disposed on and coupled to an exterior 78 of vehicle 10 within a charging port 80. Charging receptacle 72 includes a first housing 82 and conductive female terminals 84, 86. First housing 82 is coupled to exterior 78 and extends along an axis 88. First housing 82 includes an end surface 90 and a side surface 92. End surface 90 is configured to directly engage charging plug 37 and may be a generally flat surface as shown. Side surface 92 extends from end surface 90 along axis 88. Female terminals 84, 86 are disposed on end surface 90 and housed within housing 82. Female terminals 84, 86 create at least part of a conductive path connecting charging receptacle 72 and battery pack 22. Female terminals 84, 86 are configured to receive complementary male terminals 94, 96, respectively, of charging plug 37.

SOC indicator 74 conveys information about the current SOC by displaying a color that varies along a visible color spectrum. The color displayed is based on the current SOC. In various implementations, the color varies from a red color when the current SOC is relatively low to a green color when the current SOC is relatively high. The color further continuously varies along a portion of the visible spectrum when the current SOC is within a predetermined range. It is contemplated that various colors and portions of the visible spectrum can be used to communicate the current SOC. In an exemplary implementation, when the current SOC is within a predetermined first SOC range from zero percent (0%) to twenty-five percent (25%), the color remains a red color. When the current SOC is within a predetermined second SOC range from twenty-six (26%) to eighty-nine percent (89%), the color varies from a blue color at twenty-six (26%) to a purple color at eighty-nine (89%). More specifically, the color varies gradually and continuously from the blue color to the purple color such that a number of colors in a color spectrum between the blue color and the purple color are displayed. When the current SOC is within a predetermined third SOC range from ninety percent (90%) to one hundred percent (100%) or fully charged, the color remains a green color.

SOC indicator 74 is disposed on and coupled to exterior 78 within charging port 80 adjacent charging receptacle 72. SOC indicator 74 includes a second housing 100 and a lighting component 102. According to the present example, second housing 100 is a separate part from first housing 82 of charging receptacle 72. However, in various implementations, second housing 100 may be integral to first housing 82 as a single piece part. Second housing 100 houses the lighting component 102 and includes an exterior including a display face 104, a back face 106, side surfaces 108, 110, and an interior defined by an inner surface. Display face 104 faces away from exterior 78 and is semi-transparent at least in a display area adjoining an area within second housing 100 where lighting component 102 is located. Back face 106 faces exterior 78. Side surfaces 108, 110 extend between and connect display face 104 and back face 106.

According to the second embodiment, second housing 100 has a generally annular shape and circumscribes charging receptacle 72. Display face 104 adjoins and is substantially flush with end surface 90 of charging receptacle 72. Back face 106 directly engages exterior 78. Side surface 108 directly contacts side surface 92 of charging receptacle 72. Second housing 100 can be directly attached to one of exterior 78 and charging receptacle 72 by various connection methods. For example, second housing 100 can be press fit on charging receptacle 72 and/or exterior 78. Alternately or additionally, second housing 100 can be attached to exterior 78 and or charging receptacle 72 via a bolted connection.

Lighting component 102 is disposed in the interior of second housing 100 on the inner surface and is operable to emit light of the desired color through the display area. Lighting component 102 includes one or more lighting sources. According to the second embodiment, lighting component 102 includes a red LED light source 120, a green LED light source 122, and a blue LED light source 124 (collectively, RGB LED light sources 120, 122, 124) arranged in close proximity. RGB LED light sources 120, 122, 124 can be arranged in that order at predetermined radial distances from axis 88 as shown in FIG. 4. Alternately, or additionally, RGB LED light sources 120, 122, 124 can be arranged in that order at predetermined angular positions about axis 88. RGB LED light sources 120, 122, 124 can be operated via separate power circuits connected to a common power source, such as battery pack 22.

RGB LED light sources 120, 122, 124 are each selectively operable to emit light at various intensities and cooperate to display the desired color. By simultaneously illuminating two or more of the light sources and varying the intensities, colored light produced by the light sources mixes to produce the color displayed by the lighting component 102. For example, red LED light source 120 and blue LED light source 124 can be simultaneously operated at various intensities to vary the color displayed from a red color to a purple color to a blue color.

Access door 76 is disposed adjacent to an opening of charging port 80 and provides selective access to charging receptacle 72. Access door 76 is mechanically coupled to exterior 78 via a hinge mechanism 130. In a closed position, access door 32 covers the opening of charging port 80. In an open position, access door 76 provides access to charging receptacle 72 via charging port 80.

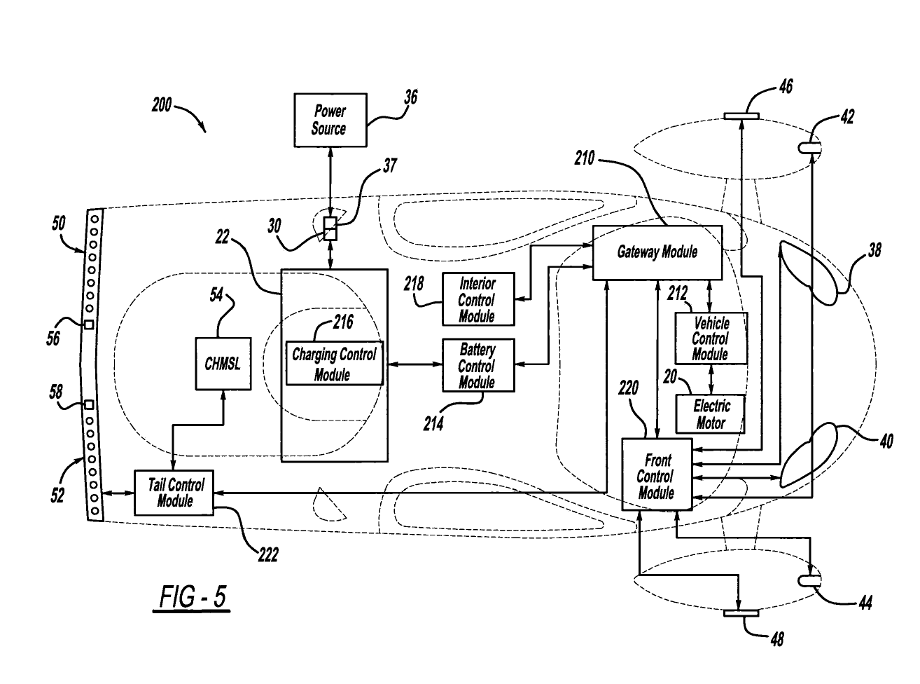

Referring now to FIG. 5, an exemplary vehicle control system 200 for vehicle 10 according to the present invention is shown. Generally, vehicle control system 200 includes various modules in communication that control the operation of vehicle 10. In particular, vehicle control system 200 controls operation of the various components of the electric drive system, including electric motor 20 and battery pack 22. Vehicle control system 200 further controls operation of the various exterior lighting components, including headlights 38, 40, front position/directional indicators 42, 44, sidemarker lights 46, 48, tail lights 50, 52, CHMSL 54, and reversing lights 56, 58.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) micro processor/controller. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage. Nonvolatile memory includes random access memory (RAM) and read only memory (ROM).

According to the present example, vehicle control system 200 includes a gateway module 210, a vehicle control module (VCM) 212, a battery control module (BCM) 214, a charging control module (CCM) 216, an interior control module (ICM) 218, a front control module (FCM) 220, and a tail control module (TCM) 222. Gateway module 210 functions as a central processing unit and communication gateway for vehicle 10. More specifically, gateway module 210 functions as a controller-area network (CAN) or CAN-bus gateway. Gateway module 210 generally controls and monitors operation of various electrical systems. Gateway module 210 receives and communicates various vehicle signals, including signals generated by the various modules of vehicle system 200, signals generated by various sensors, and other components of vehicle 10.

VCM 212 functions as an input/output (I/O) device controlling communication of various inputs and output signals between components of the electric drive system, including electric motor 20, and gateway module 210. The inputs and outputs include control signals controlling the electric drive system and other power train operations or executions. BCM 214 controls and monitors operation of battery pack 22. Battery control module 214 controls contactors of battery pack 22 and monitors voltage isolation circuits, temperature and other operating parameters of battery pack 22. BCM further functions as an I/O device controlling communication of various inputs and outputs between battery pack 22 and gateway module 210.

CCM 216 controls and monitors recharging of battery pack 22. CCM 216 is coupled to charging receptacle 30 and detects when external power source 36 is connected to vehicle 10. In various implementations, CCM 216 detects external power source 36 by detecting a voltage potential between terminals (e.g., female terminals 84, 86) of charging receptacle 30. CCM 216 controls a start and an end of each recharging event. During recharging, CCM 216 controls an amount of energy supplied to battery pack 22.

ICM 218 functions as an I/O device controlling the communication of various inputs and output signals between gateway module 210 and various components located in a passenger area of vehicle 10. The various components include, but are not limited to interior lighting components, passenger door switches and window regulators, an instrument panel, and driver interface devices and controls. The driver interface devices and controls include, but are not limited to steering, braking, lighting, door, window, entertainment, and other driver-manipulated control devices.

FCM 220 functions as an I/O device controlling the communication of various inputs and output signals between gateway module 210 and various modules and other components located forward of the passenger compartment. The various components include, but are not limited to, headlights 38, 40, front position/directional indicators 42, 44, and sidemarker lights 46, 48. TCM 222 functions as an I/O device controlling communication of various inputs and output signals between gateway module 210 and various modules and other components located rearward of the passenger compartment. The various components include, but are not limited to, tail lights 50, 52, CHMSL 54, and reversing lights 56, 58.

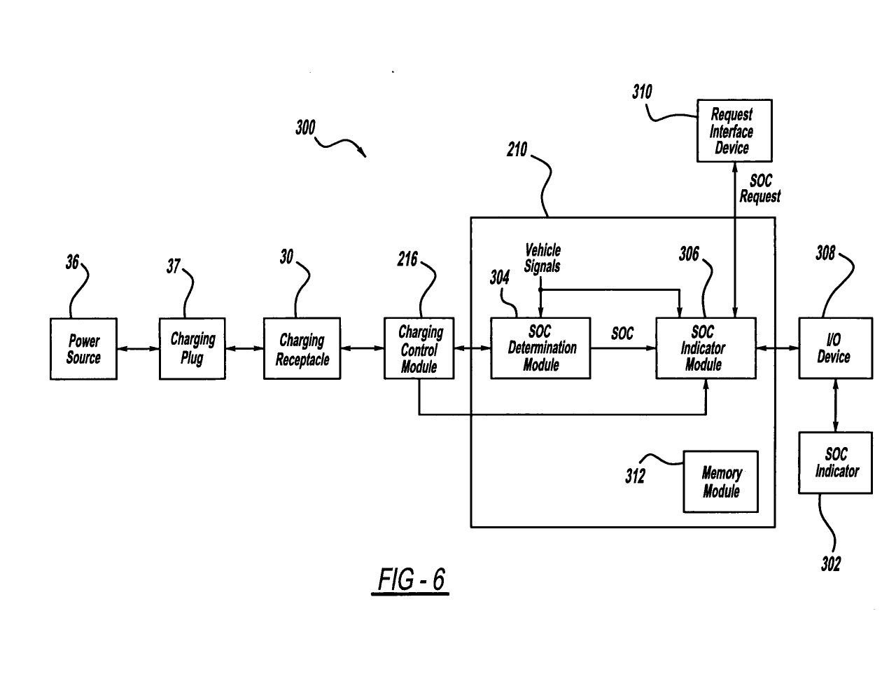

Referring now to FIG. 6, an exemplary SOC indicator system 300 for controlling an external SOC indicator 302 according to the present invention is shown. SOC indicator system 300 can be implemented in various modules of vehicle control system 200. External SOC indicator 302 is an external SOC indicator according to the present invention, such as, for example, SOC indicator 60 and SOC indicator 74. In an exemplary implementation, SOC indicator system 300 includes an SOC determination module 304, an SOC indicator module 306, an I/O device 308, a request interface device 310, and a memory module 312. In various implementations, SOC determination module 304, SOC indicator module 306, and memory module 312 can be implemented in gateway module 210. I/O device 308 can be implemented in one or more of FCM 220 and TCM 222 depending on the particular lighting components or combination of lighting components creating SOC indicator 302.

SOC determination module 304 periodically determines a current SOC of the electric drive system, and more particularly, of battery pack 22. SOC determination module 304 determines the current SOC during periods when vehicle 10 is operated, including when vehicle 10 is keyed on and is in a park mode, and during periods when vehicle 10 is not operated and/or is recharging. SOC determination module 304 may determine the current SOC at predetermined intervals that vary, depending on whether vehicle 10 is being operated or is recharging. SOC determination module 304 communicates the current SOC to SOC indicator module 306 and stores the current SOC in memory module 312.

The present invention is not limited to a particular method of determining the current SOC and SOC determination module 304 may determine the current SOC based on various operating parameters of the electric drive system. For example, the operating parameters can include, but are not limited to, a previous SOC, a battery voltage, a battery current, and a battery temperature. In an exemplary implementation, SOC determination module 304 measures a battery current and uses a current integration, or coulomb counting method, to determine the current SOC. Accordingly, SOC determination module 304 receives and monitors various vehicle signals indicative of the operating parameters used to determine the current SOC.

SOC indicator module 306 selectively illuminates SOC indicator 302 to convey information about the current SOC by outputting timed control signals to I/O device 308 based on the current SOC. SOC indicator module 306 may receive the current SOC from SOC determination module 304 or retrieve the current SOC from memory module 312. In various implementations, SOC indicator module 306 monitors operation of SOC indicator 302 to determine whether one or more light sources has failed or is otherwise inoperable. In implementations where a light source malfunctions at a first intensity but can be illuminated at a second intensity, SOC indicator 302 may illuminate SOC indicator 302 at the second intensity in order to properly convey the current SOC.

In various implementations, SOC indicator module 306 conveys the current SOC continuously during a period of recharging vehicle 10. In alternate implementations, SOC indicator module 306 conveys the current SOC intermittently at predetermined intervals during the period of recharging. In still other implementations, SOC indicator module 306 conveys the current SOC for a predetermined period in response to an SOC request communicated to SOC indicator module 306 by request interface device 310. In various implementations where SOC indicator 302 has a dual purpose, such as SOC indicator 60, SOC indicator module 306 refrains from illuminating SOC indicator 302 to convey information about the current SOC during periods when vehicle 10 is being driven. Where SOC indicator 302 has a dual purpose, SOC indicator module 306 may illuminate SOC indicator 302 for a predetermined period only in response to an SOC request when vehicle 10 is operated in a park mode.

I/O device 308 controls communication of various inputs and output signals between SOC indicator 302 and SOC indicator module 306, including the timed control signals used to illuminate SOC indicator 302. Request interface device 310 is a device external to vehicle 10 configured to generate the SOC request and communicate the SOC request to SOC indicator module 306. The present invention is not limited to a particular communication method. For example, request interface device 310 can communicate the SOC request to SOC indicator module 306 via a wired connection or a wireless connection. In various implementations, request interface device 310 is a device coupled to the exterior of vehicle 10, such as a dedicated button or a dual purpose door handle that is also used to open a door. In various other implementations, request interface device 310 is a portable device carried by a user, such as, for example, an electronic key fob or cell phone.

Request interface device 310 generates the SOC request in response to a user input. In a preferred implementation, request interface device 310 is an electronic key fob used to access the vehicle 10. In various related implementations, the SOC request may be automatically generated when vehicle 10 is parked and the key fob is within a range of detection by SOC indicator module 306. The range of detection may be from at least around six to ten feet away from vehicle 10, for example. Alternately, or additionally, the SOC request may be generated in response to a user manipulating one or more buttons of the key fob in a predetermined manner or sequence.

Referring now to FIG. 7, another exemplary external SOC indicator 350 according to the present invention is shown. SOC indicator 350 includes light sources or lighting sections 352, 354, 356, 358, 360, 362 having a closed or generally circular arrangement. In various implementations, lighting sections 352, 354, 356, 358, 360, 362 can be illuminated in predetermined combinations based on the current SOC to create a cycle graph indicator of the current SOC. For example, lighting section 352 can be illuminated and lighting sections 354, 356, 358, 360, 362 can remain off when the current SOC is within a predetermined first SOC range. Lighting sections 354, 356, 358, 360, 362 can be progressively illuminated as the current SOC increases to within predetermined second, third, fourth, fifth, and sixth SOC ranges, respectively.

Referring now to FIGS. 8-9, another external SOC indicator 370 according to the present invention is shown. SOC indicator 370 is integrated to a plug 372 selectively engageable with a charging receptacle (e.g., charging receptacle 72) of vehicle 10. In various implementations, plug 372 is a plug used to connect an external power source (e.g., external power source 36) to the charging receptacle and conveys information about the current SOC of vehicle 10. Plug 372 can be integral to or a separate part from wiring 374 used to communicate energy from the external power source to vehicle 10. Plug 372 includes a housing 376, terminals 378, and a lighting component 380. Housing 376 includes an end face 382 that directly contacts a charging receptacle of vehicle 10 when engaged.

Terminals 378 are disposed on end face 382 and connect to terminals of the charging receptacle (e.g., female terminals 84, 86). Terminals 378 include first terminals 384, second terminals 386, and optionally a third terminal 388. First terminals 384 create at least part of a conductive path connecting the external power source to the charging receptacle. First terminals 384 communicate energy from the external power source to the charging receptacle when recharging vehicle 10. Second terminals 386 create part of a conductive path used to power lighting component 380.

In various implementations, plug 372 houses a module (not shown) that selectively illuminates lighting component 380 according to the teachings set forth herein. The module can function substantially similar to SOC indicator module 306 discussed above. In such implementations, third terminal 388 creates at least part of a communication path connecting the module to vehicle 10. Third terminal 388 is used to communicate a current SOC of vehicle 10 to the module and/or, optionally, a request to display the current SOC.

Lighting component 380 displays the current SOC when illuminated. In various implementations, lighting component 380 is controlled by a module integrated with plug 372, or a module, such as SOC indicator module 306, attached to vehicle 10. Lighting component 380 is arranged on housing 376 to emit light away from vehicle 10 when plug 372 is engaged. In various implementations, lighting component 380 includes lighting sections selectively illuminated in various combinations to convey the current SOC. In various other implementations, lighting component 380 includes a light that emits light that varies in color along a color spectrum to display the current SOC.

The foregoing description presents various external SOC indicators for externally conveying information about the current SOC of a vehicle. In particular, the external SOC indicators are illuminated in various illumination states to convey various SOCs. In various implementations, the illumination states include states in which various predetermined combinations of lights are illuminated. In various other implementations, the illumination states include states that vary in a color displayed and, more particularly, the color may continuously vary along a color spectrum.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. It is intended by the following claims to cover these and any other departures from the disclosed embodiments which fall within the true spirit of this invention.

What is claimed is:

1. A system for an automotive vehicle, comprising:
a charging receptacle located on an exterior of the vehicle within a charging port, the charging receptacle accessible via the charging port;
a light located on the exterior and spaced apart from the charging receptacle and the charging port; and
a controller selectively illuminating the light based on an electric drive system state of charge (SOC).

2. The system of claim 1, wherein the controller illuminates the light in a first illumination state when the SOC is within a predetermined first SOC range and illuminates the light in a second illumination state different than the first illumination state when the SOC is within a predetermined second SOC range different than the first SOC range.

3. The system of claim 2, wherein the light includes multiple light sources, and wherein in the first illumination state, a first combination of the light sources is illuminated, and in the second illumination state, a second combination of the light sources is illuminated.

4. The system of claim 1, wherein the controller causes a color of the light to continuously vary along a color spectrum based on the SOC.

5. An automotive vehicle system, comprising:
(a) a light adapted to be attached to an exterior of a vehicle; and
(b) a module selectively illuminating the light during a vehicle stationary period based on an electric drive system state of charge (SOC), and selectively illuminating the light during a vehicle driven period based on at least one vehicle operating condition different than the electric drive system SOC.

6. The system of claim 5, further comprising a user interface device generating a user request in response to a user input, wherein the module illuminates the light based on the electric drive system SOC in response to the user request.

7. The system of claim 6, wherein the user interface device is portable by the user.

8. The system of claim 6, wherein the user interface device is an electronic key fob used to access the vehicle.

9. The system of claim 5, wherein the module selectively illuminates lighting sections of the light based on the electric drive system SOC, the lighting sections being powered by separate power circuits.

10. The system of claim 9, wherein the module illuminates a first combination of the lighting sections to indicate a first electric drive system SOC and illuminates a second combination of the lighting sections different than the first combination to indicate a second electric drive system SOC different than the first electric drive system SOC.

11. The system of claim 5, wherein the module continuously varies a color displayed by the light along a color spectrum based on the electric drive system SOC.

12. The system of claim 11, wherein the light includes a first light source producing a first colored light and a second light source producing a second colored light that mixes with the first colored light, and wherein the module varies the color by varying at least one of a first intensity of the first colored light and a second intensity of the second colored light.

13. The system of claim 12, wherein the first light source includes a first light emitting diode (LED) and the second light source includes a second light emitting diode.

14. The system of claim 5, wherein the light is a tail light used to perform at least one of a rear position indicator function and a brake warning function during the vehicle driven period.

15. A system for an automotive vehicle, comprising:
a battery;
a charging receptacle attached to an exterior of the vehicle, the charging receptacle including a first housing and terminals at least partially located in the first housing, the terminals creating at least part of a conductive path connecting the charging receptacle and the battery;
a lighting component including a second housing and a light source arranged on the second housing to externally emit light away from the vehicle, the second housing circumscribing the first housing; and
a module selectively illuminating the lighting component based on a state of charge (SOC) of the battery.

16. The system of claim 15, wherein the module continuously varies a color displayed by the light source along a color spectrum based on the SOC.

17. The system of claim 16, wherein the lighting component includes a first light source producing a first colored light and a second light source producing a second colored light that mixes with the first colored light, and wherein the module varies the color by varying at least one of a first intensity of the first colored light and a second intensity of the second colored light.

18. The system of claim 17, wherein the first light source includes a first light emitting diode and the second light source includes a second light emitting diode.

19. The system of claim 15, further comprising a user interface device generating a user request in response to a user input, wherein the module illuminates the lighting component in response to the user request.

20. The system of claim 19, wherein the user interface device is portable by the user.

21. The system of claim 19, wherein the user interface device is an electronic key fob used to access the vehicle.

22. A system for an automotive vehicle, comprising:
(a) an automotive vehicle battery;
(b) an externally accessible charging receptacle including:
(i) a first face, and
(ii) first terminals located on the first face, the first terminals creating at least part of a conductive path connecting the charging receptacle and the battery;
(c) a plug selectively engageable with the charging receptacle, the plug including:
(i) a second face directly contacting the first face when the plug is engaged with the charging receptacle,
(ii) second terminals disposed on the second face and connecting to the first terminals, and
(iii) a light connecting to at least one of the first terminals via the second terminals, the light arranged on the plug to externally emit light away from the vehicle when the plug is engaged; and
(d) a controller causing illumination of the light based on a state of charge (SOC) of the battery via the at least one of the first terminals, wherein the controller:
causes illumination of the light in a first illumination state when the SOC is within a predetermined first SOC range, and
(ii) causes illumination of the light in a second illumination state different from the first illumination state when the SOC is within a predetermined second SOC range different than the first SOC range.

23. The system of claim 22, further comprising a user interface device generating a user request in response to a user input, wherein the controller causes illumination of the light in response to the user request.

24. The system of claim 23, wherein the user interface device is portable by the user.

25. The system of claim 23, wherein the controller is attached to the vehicle.

26. The system of claim 22, wherein the plug is a separate part from wiring connecting an external power source to the vehicle.

27. The system of claim 22, wherein the controller causes a color of the light to continuously vary along a color spectrum based on the SOC.

28. A method for indicating a state of charge (SOC) of an automotive vehicle, the method comprising:
selectively illuminating a light disposed on an exterior of the vehicle during a first period when the vehicle is stationary based on a SOC of an electric drive system; and
selectively illuminating the same light during at least a second period when the vehicle is driven based on a vehicle operating condition different than the SOC of the electric drive system.

29. The method of claim 28, further comprising generating a user request in response to a user input to a user interface device, wherein the selectively illuminating the light during the first period includes illuminating the lighting component in response to the user request.

30. The method of claim 29, wherein the user interface device is portable by a user.

31. The method of claim 29, wherein the user interface device is an electronic key fob used to access the vehicle.

32. The method of claim 28, wherein the selectively illuminating the light during the first period includes selectively illuminating multiple light sources, each of the light sources being powered by separate power circuits.

33. The method of claim 32, wherein the selectively illuminating the light sources includes:
illuminating a first combination of the light sources to indicate a first SOC; and
illuminating a second combination of the light sources different than the first combination to indicate a second SOC different than the first SOC.

34. The method of claim 32, wherein the selectively illuminating the light sources includes varying at least one of a first intensity of a first colored light produced by a first one of the light sources and a second intensity of a second colored light produced by a second one of the light sources.

35. The method of claim 28, wherein the light is one of a group of lights located at different locations on the exterior.

36. The method of claim 28, wherein the light is a tail light used to perform at least one of a rear position indicator function and a brake warning function during the second period.

37. The method of claim 28, wherein the selectively illuminating the light during the first period includes continuously varying a color displayed by the light along a color spectrum.

38. A method for indicating a state of charge (SOC) of an automotive vehicle, the method comprising:
(a) attaching a charging receptacle to an exterior of the vehicle, the charging receptacle creating a conductive path connecting the charging receptacle and a battery of the vehicle;
(b) engaging a plug with the charging receptacle, the plug being separate from the charging receptacle and including lights operable to externally emit light away from the vehicle; and
(c) selectively illuminating the lights based on a SOC of the battery, the selectively illuminating including:
(i) illuminating a first combination of the lights when the SOC of the battery is within a predetermined first SOC range, and
(ii) illuminating a second combination of the lights different than the first combination when the SOC of the battery is within a predetermined second SOC range different than the first SOC range.

39. The method of claim 38, further comprising generating a user request in response to a user input to an interface device, wherein the selectively illuminating the lights is in response to the user request.

40. A method for indicating a state of charge (SOC) of an automotive vehicle, the method comprising:
(a) attaching a charging receptacle to an exterior of the vehicle, the charging receptacle creating a conductive path connecting the charging receptacle and a battery of the vehicle;
(b) engaging a plug with the charging receptacle, the plug being separate from the charging receptacle and including a light operable to externally emit colored light away from the vehicle; and
(c) selectively illuminating the light based on a SOC of the battery, the selectively illuminating including continuously varying a color of the colored light along a color spectrum based on the SOC of the battery.

41. The method of claim 40, further comprising generating a user request in response to a user input to an interface device, wherein the selectively illuminating the light is in response to the user request.
